(19) United States
(12) Patent Application Publication
(10) Pub. No.: US 2007/0296198 A1
(43) Pub. Date: Dec. 27, 2007

(54) Belt Tensioning Unit

(75) Inventors: Walter Eberle, Hochdorf (DE); Felix Maus, Korntal-Muenchingen (DE); Christian Mayer, Ditzingen (DE); Albert Reitinger, Berglen (DE); Markus Woldrich, Ditzingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/576,810

(22) PCT Filed: Oct. 20, 2004
(86) PCT No.: PCT/EP04/11862

§ 371 Date: Feb. 1, 2007

(30) Foreign Application Priority Data
Oct. 22, 2003 (DE) 103 49 178.3

(51) Int. Cl. B60R 22/46

(52) U.S. Cl. 280/806

(57) ABSTRACT

A belt tensioning unit has a reversible clamping device which is controlled by a sensor system which is capable of recognizing potentially dangerous or accident-prone driving situations. In the event of danger, the belt is tensioned with sufficient force in order to draw the occupant into a desired sitting position prior to a possible collision or to retain the occupant in this position.

### BACKGROUND AND SUMMARY OF THE INVENTION

This invention relates to a belt tensioning unit of a seat belt, which can be retracted on a belt reel, for an occupant on a seat in a vehicle, in particular motor vehicle. The unit includes a return device, which is connected in terms of drive to the belt reel, for automatically shortening the belt, and an extension lock of the belt, which extension lock is effective at a predetermined deceleration or acceleration of the vehicle or of its body and/or when a predetermined extension speed of the belt is exceeded. The unit further includes a sensor system which is capable of recognizing potentially dangerous and/or accident-prone driving situations, and a reversible clamping device, which interacts with the sensor system and can be driven by means of an associated motor. The motor of the clamping device drives the belt reel in the clamping direction of the belt as a function of signals of the sensor system and sets an increased belt tension.

Standard belt tensioning units currently installed in motor vehicles typically have return devices actuated by spiral springs. This ensures that, in such a unit, the belt, when not in use, is automatically wound up and, when in use, can be extended to the necessary length and can follow (slow) movements of the occupant.

The extension lock operates using mechanical catch elements which can be controlled, on the one hand, by inertia elements and, on the other hand, by centrifugal elements. The inertia elements shift from a catch-ineffective position into a catch-effective position if forces acting on the vehicle body cause an acceleration or deceleration of the body that exceeds a low threshold value. The centrifugal elements are catch-effective if the belt reel, which is used for receiving the belt, is rotated at a rotational acceleration exceeding a threshold value or is rotated abruptly in the extension direction of the belt. The abovementioned measures ensure that the belt is securely locked against further extension of the belt in the case of dangerous driving situations or accidents.

In order to improve comfort, according to German document DE 39 38 081 A1, a spiral spring provided for actuating the return device can be assigned an electric motor with which the relatively stationary abutment of the abovementioned spring can be adjusted. In this manner, the belt tension can be changed and, even with a greatly extended belt, as is necessary if the occupant is of above-average height or plumpness, the belt tension remains comparatively low and, accordingly, the wearing comfort is improved. As soon as the belt is guided back to be wound up, the relatively stationary abutment is guided back into a starting position by the abovementioned motor in order to be able to securely wind up the belt.

Similar arrangements are also illustrated in German documents DE 41 12 620 A1 and DE 195 01 076 A1.

It is known from German documents DE 100 05 010 A1 and DE 100 13 870 A1 to provide belt tensioning units with a reversible clamping device driven by a motor, in order, as a function of signals of a sensor system, to be able to recognize potentially dangerous and/or accident-prone driving situations and to increase the belt tension. The sensor system may recognize, for example, a driver's actuation of gas and brake pedals and/or the relative speed of the vehicle and its distance from a preceding vehicle or object and/or the sitting position of the occupant secured by the belt. This provides the possibility of using the reversible clamping device, in dangerous driving situations, to draw the secured occupant with increased and, if appropriate, different forces into a predetermined sitting position and/or to use reduced forces to keep him in such a sitting position.

The abovementioned reversible clamping device is to be differentiated from a frequently present, irreversible clamping device which is typically actuated pyrotechnically as soon as a sensor present in the vehicle indicates a—severe—collision. Irreversible clamping devices are unsuitable for use in the case of merely potentially dangerous driving situations which do not necessarily have to be followed by an accident, precisely because said clamping devices are only provided for a single actuation and, after being actuated once, require the vehicle to visit a garage in order to make the irreversible clamping device usable again.

It is the object of the invention to provide a reversible clamping device which makes it possible in a structurally simple manner to set different tensile forces for the belt.

This object is achieved by having a two-path transmission arranged between the motor of the reversible clamping device and the belt reel, the paths of which transmission have different transmission ratios with correspondingly different intensification of the torque on the belt reel in comparison to the torque of the motor, with the path with high intensification of the torque being able to be switched on or being switched on in the event of a signal, which can be produced by the sensor system, for accident-prone driving situations and the other path being able to be switched on or being switched on if such a signal is absent and/or in the case of a signal, which can be produced by the sensor system, for a merely potentially dangerous driving situation.

The invention is based on the general concept, with regard to the currently comparatively low load-bearing capacity of electric supply systems of vehicles, of using relatively low-powered, rapidly running electric motors for the actuation of the reversible clamping device and of providing the high torque desired in each case at the belt reel by means of a step-down transmission arranged between motor and belt reel. By means of the two-path transmission according to the invention, different belt tensions can readily be produced, since the two paths of the transmission have different transmission ratios with correspondingly different intensification of the torque on the belt reel in comparison to the torque of the motor. The path with high intensification of the torque is switched on in the case of the signal for near-accident driving situations, and the other path is switched on in the case of less dangerous situations.

A particular structural simplicity arises if the two-path transmission can be switched over by reversing the direction of rotation of the motor, and the belt reel rotates relative to the motor in one direction of rotation when the one path is switched on and in the opposite direction of rotation when the other path is switched on, i.e. irrespective of the change in direction of rotation of the motor, the belt reel rotates in the winding-up direction, to be precise with different winding force depending on the direction of rotation of the motor.

Moreover, it is advantageous that the paths of the two-path transmission, which paths are assigned to the directions of rotation of the motor, can be switched on inevitably and without particular control measures if two freewheels are provided which are each assigned to one of the paths of the transmission, the one freewheel locking in the one direction of rotation and the other freewheel locking in the other direction of rotation of the motor.

According to a further advantageous embodiment, between input and output of the two-path transmission, i.e. between its motor connection and its belt reel connection, there is firstly arranged a direct frictional connection and secondly an interlocking drive train, which is stepped down in comparison to the frictional connection and which, when the output moves in a direction of movement associated with the clamping direction of the belt reel, is free from inevitably being coupled in the direction of the input. In this embodiment, the two paths of the transmission are effective as a function of the belt tension: as long as the belt is only acted upon by a small force, the belt reel can rotate with little torque in the clamping direction of the belt. As long as this low torque remains smaller than the torque which can be transmitted via the frictional connection, the transmission output is driven via the direct frictional connection.

If the belt tension now achieves a greater dimension, the frictional connection is no longer sufficient to overcome the resistance opposing a rotation of the belt reel in the clamping direction of the belt. This has the consequence that the frictional transmission elements will slip through and become virtually ineffective. The rotational speed of the belt reel is now determined by the greatly stepped-down, interlocking drive train.

According to a preferred embodiment, the interlocking drive train can be designed to be self-locking in relation to forces and torques acting from the output on the input, with the result that, after a desired belt tension is set, the motor of the reversible belt tensioning unit does not have to produce virtually any retaining force.

Furthermore, with regard to preferred features of the invention, reference is made to the claims and the description below of the drawings in which particularly preferred embodiments of the invention are illustrated in more detail.

Protection is claimed not only for the expressly illustrated or described combinations of features, but in principle for any desired sub-combinations of the abovementioned combinations of features.

### BRIEF DESCRIPTION OF THE DRAWINGS

FIG. 1 shows a schematized illustration of a belt tensioning unit according to the invention,

FIG. 2 shows an axial section of a two-path transmission which is designed as a planetary transmission and the paths of which are switched on or over by a change in the direction of rotation of a transmission input,

FIG. 3 shows an axial section of a two-path cylindrical transmission, the paths of which are likewise switched on or over by a change in the direction of rotation of a transmission input,

FIG. 4 shows a sectional drawing corresponding to the sectional plane IV-IV in FIG. 3,

FIG. 5 shows an axial section of a two-path transmission, the paths of which become effective as a function of the transmitted torque,

FIG. 6 shows a sectional drawing according to the sectional line VI-VI in FIG. 5, and

FIG. 7 shows a diagrammatic illustration of a further exemplary embodiment of a two-path transmission.

### DETAILED DESCRIPTION OF THE INVENTION

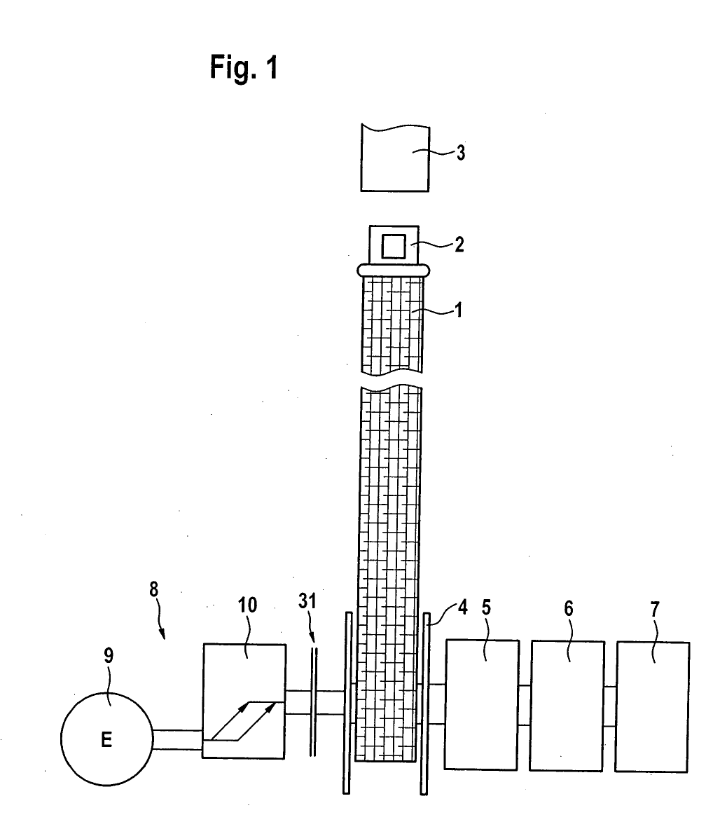

According to FIG. 1, a seat belt 1 has, in a known manner, a buckle latch 2 which can be introduced into a belt buckle 3 or can be separated from the belt buckle 3. The seat belt 1 is wound up onto a reel 4 in such a manner that the seat belt 1 has the respectively desired or required length, as is illustrated further below.

The reel 4 is assigned, in a known manner, a mechanical extension lock 5 which locks the reel 4 against a rotation in the unwinding direction of the seat belt if the rotational speed of the reel 4 and/or the acceleration or deceleration of the vehicle body within which the seat belt 1 is arranged exceed a threshold value.

The extension lock 5 is combined with a return device 6 which, in a known manner, can be formed by a spiral spring (not illustrated) which is fastened, on the one hand, on a stationary abutment and, on the other hand, on an abutment, which is rotationally fixed relative to the reel 4, and attempts to rotate the reel 4 with relatively low force in the winding-up direction of the belt 1.

Furthermore, the reel 4 can be assigned an irreversible clamping device 7 which operates pyrotechnically in a known manner and is ignited if a sensor system on the vehicle recognizes a collision or an immediately imminent collision of the vehicle. In this case, the clamping device 7 brings about an irreversible tensioning of the belt with great force and rapid belt tensioning, for example up to 4000 N. The effect which can thereby be achieved is that the occupant who is secured by the seat belt 1 is firmly held on his seat in a secure manner and virtually without any clearance for movement and accordingly is optimally protected against collisions with interior parts of the vehicle.

Furthermore, the reel 4 is connected to a reversible clamping device 8. The reversible clamping device 8 has the task of temporarily clamping the belt 1 in predetermined situations. Provision is made according to the invention to monitor events on the road in the surroundings and in particular in front of the vehicle using a sensor system (not illustrated) in order to recognize potentially dangerous situations with an increased possibility of there being an accident. In such cases, the reversible clamping device 8 is then to have the effect that the occupant is brought into a predetermined normal sitting position or is held in this position. For this purpose, the belt 1 is acted upon by a corresponding force, up to approximately 1000 N.

The sensor system preferably also monitors the sitting position of the occupant in order to be able to optimize the control of the belt tension. If, in a potentially dangerous situation, the occupant is situated outside the normal sitting position, the clamping device 8 produces a high tensile force, for example up to 1000 N, in order to draw the occupant into the normal sitting position. If, in the case of an accident-prone situation, the occupant assumes his normal sitting position, the belt is clamped with significantly reduced force, for example 100 to 300 N, in order merely to guide back any possible slack of the belt 1.

The reversible clamping device 8 may essentially comprise an electric motor 9 and a two-path transmission 10 coupling the electric motor 9 to the reel 4 in terms of drive.

The two paths of the transmission have significantly different transmission ratios, with the result that, given the same motor torque, the torque available at the reel 4 is correspondingly different depending on which path of the transmission is switched on.

The switching over between the transmission paths preferably takes place by reversing the direction of rotation of the electric motor 9, the two paths being designed in such a manner that the reel 4 is driven over each transmission path in the winding-up direction of the belt 1 irrespective of the direction of rotation of the driving motor 9.

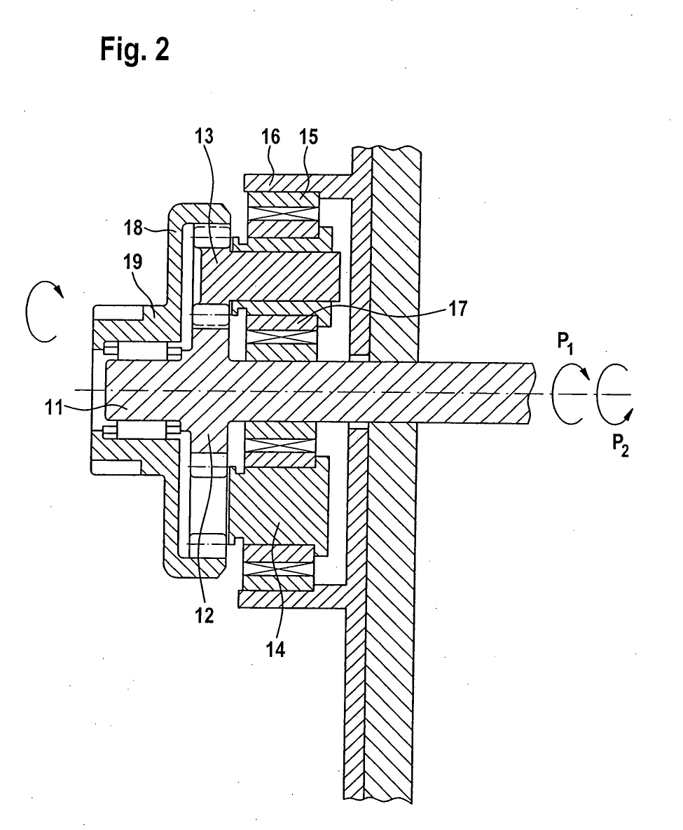

FIG. 2 shows an example of a two-path transmission 10 of this type designed as a planetary transmission.

An electric motor (not illustrated) which can be driven in the forward and backward directions is connected in terms of drive to the shaft 11 of the sun wheel 12 of the planetary transmission. The sun wheel 12 meshes with the planet wheels 13, the planet carrier 14 of which can be coupled via a first freewheel 15 to a stationary housing ring 16 and via a second freewheel 17 to the shaft 11. The freewheels 15 and 17 are designed in such a manner that the first freewheel 15 only permits a rotation of the planet carrier in the one direction of rotation, and the other freewheel 17 locks if the shaft 11 attempts to rotate in this direction relative to the planet carrier.

If, therefore, the shaft 11 is driven in the one direction, i.e. corresponding to the arrow P₁, the shaft 11 and the planet carrier 14 are coupled to each other in a rotationally fixed manner, and the planet carrier 14 rotates relative to the housing ring 16 in the direction of the shaft 11.

If the shaft 11 rotates in the opposite direction, i.e. corresponding to the arrow P₂, the second freewheel 15 locks, and the planet carrier 14 rotates, not together with the shaft 11, in the arrow direction P₂.

Accordingly, the crown wheel 18 is always driven in the arrow direction P₁ irrespective of the driving direction of the shaft 11. An output wheel formed on the crown wheel 18, for example a belt wheel 19 or gearwheel or driveshaft, is connected in terms of drive to the belt reel 4 (not illustrated in FIG. 2) in such a manner that, in the case of this direction of rotation, the belt reel 4 rotates in the winding-up direction of the belt 1.

When the shaft 11 is rotated in the direction P₁, the output wheel or belt wheel 19 is driven with a low torque in comparison to the motor torque while, in the case of the direction of rotation of the shaft 11 in the direction of the arrow P₂, a considerable intensification of the torque occurs.

The freewheels 15 and 17 are preferably configured with play in such a manner that the shaft 11 in each case only first of all has to cover a certain rotational path in the one or other direction of rotation before one of the two freewheels 15 and 17 locks. By means of this play, it can be ensured, in the manner illustrated further below, that the belt 1 can be extended with little force without the transmission of FIG. 2 locking the belt reel 4 or the electric motor driving the shaft 11 having to be rotated at the same time.

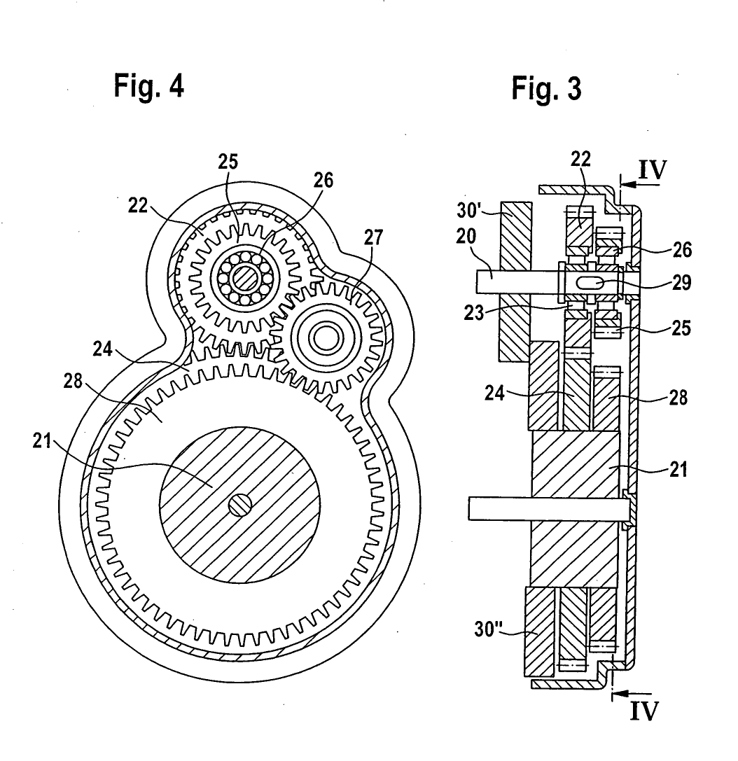

FIGS. 3 and 4 illustrate a two-path transmission designed as a cylindrical transmission. Here, an electric motor (not illustrated) drives an input shaft 20 which can be coupled in terms of drive with different transmission ratios to an output shaft or an output wheel 21 which, for its part, is connected to the belt reel (not illustrated).

A first gearwheel 22 with a first freewheel 23 is arranged on the input shaft. Said gearwheel meshes with a gearwheel 24 connected in a rotationally fixed manner to the output wheel 21. The freewheel 23 is designed in such a manner that the shaft 20 is only coupled in terms of drive with the gearwheel 22, i.e. the freewheel 23 only locks, if the input shaft 20 is driven in the one direction of rotation by the motor (not illustrated).

Furthermore, a second gearwheel 25 with a second freewheel 26 is arranged on the input shaft 20, said freewheel adopting its locking state if the input shaft is driven in the direction opposed to the abovementioned direction of rotation. The second gearwheel 25 meshes with a gearwheel 27 which is in engagement with a gearwheel 28 arranged in a rotationally fixed manner on the output wheel 21.

In this case too, the transmission of drive therefore takes place via one of two transmission paths depending in each case on the direction of rotation of the input shaft 20 and accordingly depending in each case on the direction of rotation of the motor driving the shaft 20.

If the transmission of drive is brought about by the gearwheels 22 and 24, a smaller torque in comparison to the torque of the driving motor is available at the output wheel 21 than is the case if the transmission of drive takes places via the gearwheels 25, 27 and 28.

Those parts of the freewheels 23 and 26 which are assigned to the input shaft 20 have a certain rotational clearance, which is allowed, for example, by means of a slot wedge 29, in relation to the shaft 20. The freewheels 23 and 26 may also be arranged at the bottom of the shaft 20, for example between gearwheel 24 and drive shaft 21 or gearwheel 28 and drive shaft 21.

Furthermore, a slipping clutch with the slipping clutch elements 30′ and 30″ is arranged between the output wheel 21 and input shaft 20. Within the abovementioned clearance, the motor driving the shaft 20 therefore drives the output wheel 21 in the one or other direction of rotation, depending in each case on the direction of rotation of the motor, before direction of rotation and rotational speed of the output wheel 21 are in each case predetermined by the interlocking connection of the gearwheels 22 and 24 or 25, 27 and 28.

The possibility of also driving the output wheel 21 in a backward direction can be used to control a shift clutch 31 (only illustrated diagrammatically in FIG. 1) which is arranged between the belt-side output of the transmission 10 and the belt reel 4 and closes or opens as a function of the direction of rotation of the output of the transmission 10.

Whenever the output of the transmission 10 is driven in a direction of rotation corresponding to the winding-up direction of the belt 1, the clutch 31 closes, so that the reversible clamping device 8 can bring about a reversible tensioning of the belt 1. If the output of the transmission 8 is now driven within the clearance of the freewheels of this transmission in a direction of rotation corresponding to the unwinding direction of the belt 1, the clutch 31 opens, with the consequence that the belt 1 can be extended by the occupant without this extension movement being able to be obstructed by the transmission 10 or the stationary motor 9.

The slipping torque of the slipping clutch elements 30′ and 30″ is set in such a manner that a torque necessary for the opening of the clutch 31 can be transmitted.

In the embodiment of FIG. 2, functionally corresponding slipping clutch elements can be arranged between the shaft 11 and the output wheel 19 which then, for its part, is coupled in terms of drive to the belt reel 4 via the clutch 31 of FIG. 1.

In the embodiments illustrated above with reference to the drawings, the electric motor 9 can therefore firstly open the driving connection to the belt reel 4, so that the respective occupant can easily extend the belt 1. Secondly, the electric motor 9 can drive the belt reel 4 with a differently sized torque, to be precise in the winding-up direction of the belt 1, in order to undertake reversible belt tensioning. If this belt tensioning is to take place with a large force, for example 1000 N, the motor 9 operates in that direction of rotation in which the two-path transmission 10 operates with a comparatively large transmission ratio, and, accordingly, a particularly high torque in comparison to the motor torque can be tapped off at the transmission output.

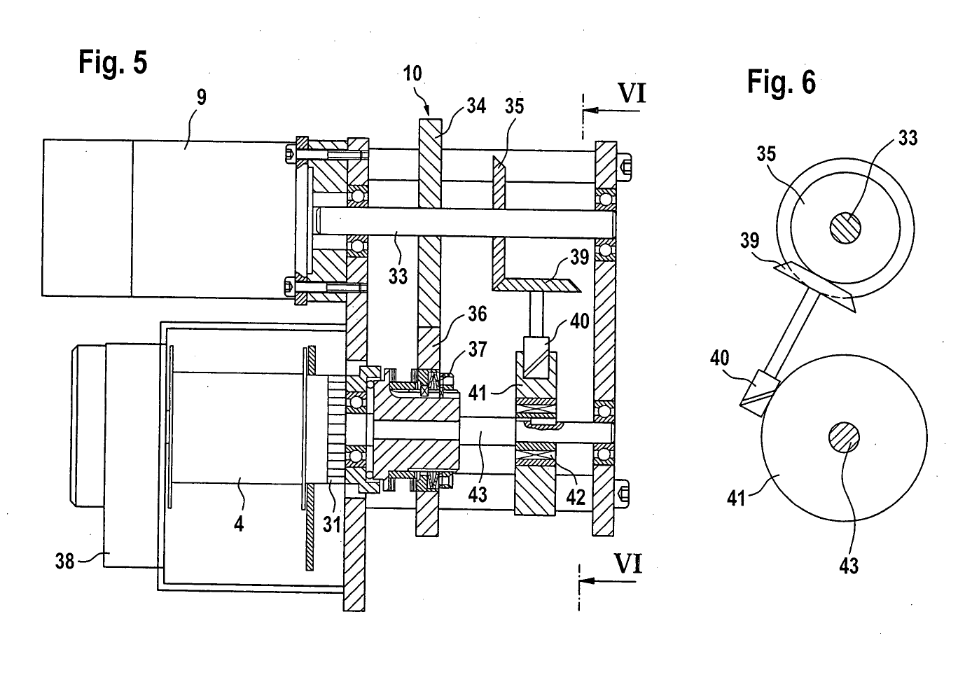

In the embodiments illustrated in FIGS. 5 and 6, the electric motor 9 drives the input shaft 33 of the two-path transmission 10. A first gearwheel 34 and a second gearwheel 35 are arranged parallel to each other in a rotationally fixed manner on the input shaft 33.

The first gearwheel 34 meshes with a gearwheel 36 which is arranged on the input side of a slipping clutch 37, the output of which is connected in terms of drive to the reel 4 of the seat belt (not illustrated here) via the clutch 31.

A housing 38 arranged on that side of the reel 4 which faces away from the clutch 31 receives the extension lock 5 and the return device 6 (compare FIG. 1).

The further gearwheel 35 forms an angular transmission with a gearwheel 39, the gearwheel 39 being connected in terms of drive via its shaft in a rotationally fixed manner to a worm 40 which interacts with a worm wheel 41.

The worm wheel 41 is connected in terms of drive via a freewheel 42 to an output shaft 43 connected in a rotationally fixed manner to the output of the slipping clutch 37. The freewheel 42 is designed in such a manner that it opens when the output shaft 43 is rotated relative to the worm wheel 41 in the winding-up direction of the reel 4. A rotation of the output shaft 43 relative to the worm wheel 41 in the unwinding direction of the reel 4 is prevented by the freewheel 42 which then locks.

The arrangement of FIGS. 5 and 6 functions as follows, with it first of all being assumed that the clutch 31 is closed. When the electric motor 9 operates in its direction of rotation assigned to the clamping direction of the belt, i.e. in the direction of rotation corresponding to the winding-up direction of the belt reel 4, the rotational speed of the reel 4 is initially determined by the gearwheels 34 and 36, as long as only forces which are lower than the torque which can be transmitted by the slipping clutch 37 oppose a rotation of the reel. The gearwheels 34 and 36, i.e. the one path of the transmission 10, operate with a significantly more direct transmission than the second path of the transmission 10 that is formed by the gearwheels 35, 39 and the worm 40 and the worm wheel 41. Owing to the freewheel 42, the reel 4 can readily be rotated in the winding-up direction of the reel 4 via the gearwheels 34 and 36 with a rotational speed which is increased in comparison to the worm wheel 41. In this manner, during operation of the electric motor 9, a rapid tensioning of the belt with a low maximum force determined by the transmittable torque of the slipping clutch 37 is possible.

As soon as the belt tension exceeds a threshold value at the belt reel 4 that is determined by the transmittable torque of the slipping clutch 37, the slipping clutch 37 slips through during operation of the electric motor 9, and the belt reel 4 is now driven via the second transmission path with a significantly reduced speed of rotation in comparison to the speed of rotation of the gearwheel 36, with, given a corresponding motor torque or corresponding step-down of the second transmission path—gearwheel 35, gearwheel 39, worm 40 and worm wheel 41—high clamping forces being able to be achieved which are possibly sufficient to draw the occupant into a desired sitting position.

If appropriate, the belt tension can be reduced by operation of the electric motor in the reverse running direction, with the speed of rotation of the reel 4 determined by the greatly stepped-down second transmission path.

Furthermore, the clutch 31 can be opened in order to decouple the reel 4 from the transmission 10. This makes it possible in particular to ensure that the belt, when put on, can easily be unrolled from the reel 4.

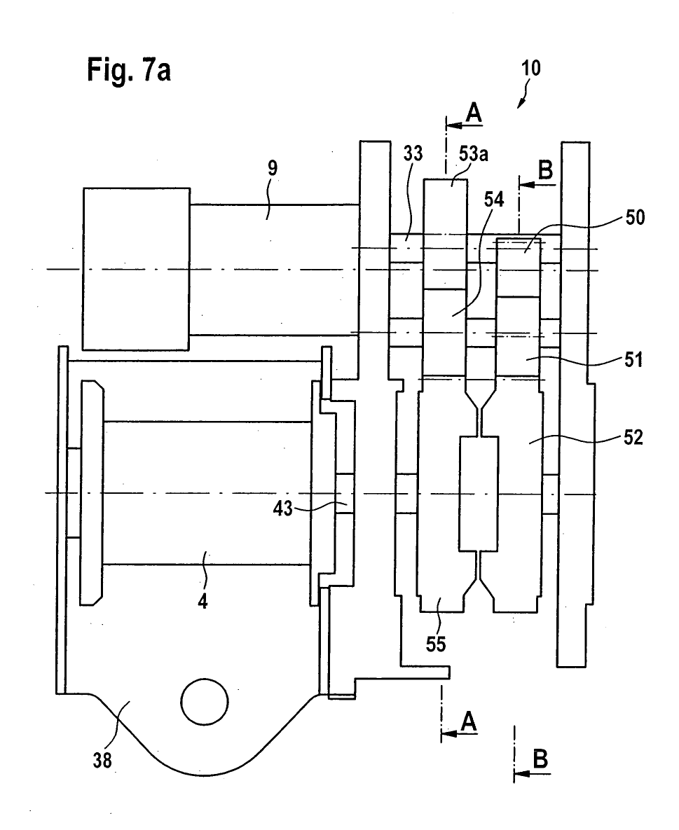

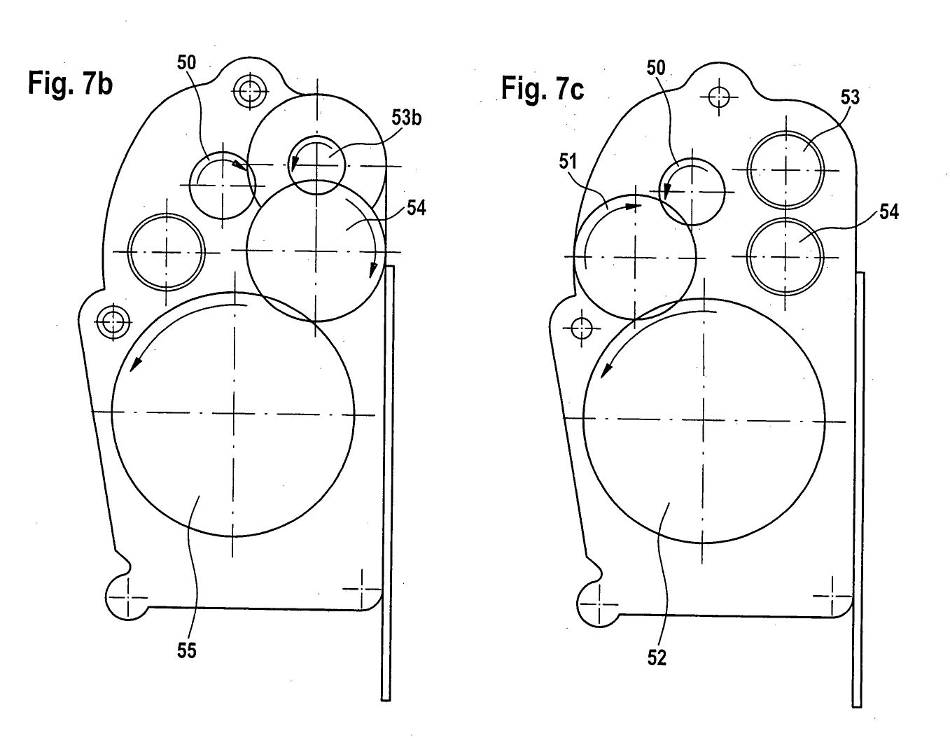

In a departure from the above described embodiments, other embodiments are in principle also possible, as illustrated, for example, in FIGS. 7a, 7b and 7c.

FIG. 7a illustrates a schematized side view of a two-path transmission 10. FIGS. 7b and 7c respectively show the sections along the lines A-A and B-B. The two-path transmission 10 differs from the transmission described in conjunction with FIGS. 3 and 4 by a different arrangement of gearwheels that is distinguished by a more compact type of construction. To achieve this purpose, two gearwheels have been fitted, so that other gearwheels can be of smaller design.

A motor 9 which acts on an input shaft 33 is provided. Two force paths which are activated by a different direction of rotation of the motor 9 are provided in the two-path transmission 10. The first force path runs via the gearwheels 53a, 53b, 54 and 55 and a frictional claw clutch (only illustrated diagrammatically). The second, more direct force path runs via the gearwheels 50, 51 and 52 and the frictional claw clutch (likewise only illustrated diagrammatically). The more direct force path has a transmission ratio of below 1:4. In the case of the other force path, the transmission ratio is around approx. 1:12. Compared with the exemplary embodiment described in conjunction with FIGS. 3 and 4, the gearwheels 51 and 54 have been joined. This is not required in principle, but makes it possible for the gearwheels 52 and 55 to be able to be of small design.

The elements designed as the frictional claw clutch are situated on the output shaft 43 in order to have low frictional losses by transmission stages not running at the same time. In order to permit the slipping clutches to be released, one of the two slipping clutches has to be configured as a shiftable slipping clutch. It is also conceivable to design the clutch as an electric clutch.

In a further advantageous refinement of the invention, it is provided that the gearwheel 53b meshes directly with the gearwheel 55. In this solution, a reversal in the direction of rotation of the motor is not required for the tensioning direction.

If appropriate, the transmission 10 can be omitted if the motor 9 can produce a controllable, large torque, with the control being possible, for example, by switching over electric motor windings.

Furthermore, instead of the transmission 10 which can be switched over by changing the direction of rotation of the transmission input, a “normal” shifting transmission can also be provided which is changed over between different transmission stages, for example by means of electric control elements.

1-16. (canceled)

17. A belt tensioning unit of a seat belt, which can be retracted on a belt reel, for an occupant on a seat in a motor vehicle, comprising:
a return device, which is connected in terms of drive to the belt reel, for automatic shortening of the belt,
an extension lock of the belt, which extension lock is effective at a predetermined deceleration or acceleration of the vehicle or of its body, when a predetermined extension speed of the belt is exceeded, or both at said predetermined deceleration or acceleration and when said predetermined extension speed of the belt is exceeded,
a sensor system which is capable of recognizing potentially dangerous driving situations, accident-prone driving situations, or both potentially dangerous driving situations and accident-prone driving situations, and
a reversible clamping device, which interacts with the sensor system and can be driven by an associated motor which drives the belt reel in a clamping direction of the belt as a function of signals of the sensor system and sets an increased belt tension,
wherein a two-path transmission is arranged between the motor of the reversible clamping device and the belt reel, and
wherein paths of the transmission have different transmission ratios with correspondingly different intensification of the torque on the belt reel in comparison to motor torque.

18. The belt tensioning unit as claimed in claim 17, wherein the two-path transmission can be switched over by reversing the direction of rotation of the motor, and wherein the belt reel rotates relative to the motor in one direction of rotation when the one path is switched on and in an opposite direction of rotation when the other path is switched on.

19. The belt tensioning unit as claimed in claim 18, wherein paths of the two-path transmission can be switched on by two freewheels, wherein one of the freewheels locks in the one direction of rotation of the motor, and wherein the other of the free wheels locks in the other direction of rotation of the motor.

20. The belt tensioning unit as claimed in claim 19, wherein the two-path transmission is designed as a planetary transmission.

21. The belt tensioning unit as claimed in claim 20, wherein a first freewheel of the two freewheels is arranged between a stationary part and a planet carrier of the planetary transmission.

22. The belt tensioning unit as claimed in claim 21, wherein a second freewheel of the two freewheels is arranged between the planet carrier and a sun wheel of the planetary transmission.

23. The belt tensioning unit as claimed in claim 19, wherein the transmission is a cylindrical transmission with paths arranged in two radial planes at a distance from each other axially.

24. The belt tensioning unit as claimed in claim 23, wherein a first freewheel of the two freewheels is arranged in one radial plane between a motor shaft and a gearwheel arranged thereon.

25. The belt tensioning unit as claimed in claim 24, wherein a second freewheel of the two freewheels is arranged in another radial plane between the motor shaft and another gearwheel arranged thereon.

26. The belt tensioning unit as claimed in claim 18, wherein there is a rotational clearance between a motor-side part of a transmission input and a transmission output, and wherein a slipping clutch is arranged between the transmission input and the transmission output, via which slipping clutch the transmission output can be driven within the rotational clearance in a forward or a backward direction depending on a direction of rotation of the transmission input.

27. The belt tensioning unit as claimed in claim 17, wherein, between an input and an output of the two-path transmission, there are arranged a direct frictional connection and an interlocking drive train, which is stepped down in comparison to the frictional connection and, when the output moves in a direction of movement associated with the clamping direction of the belt reel, is free from inevitably being coupled in the direction of the input.

28. The belt tensioning unit as claimed in claim 27, wherein the interlocking drive train is designed to be self-locking in relation to the transmission of force from the output to the input.

29. The belt tensioning unit as claimed in claim 28, wherein an input worm interacts with an output worm wheel in the interlocking drive train.

30. The belt tensioning unit as claimed in claim 27, wherein the direct frictional connection is designed as a slipping clutch.

31. The belt tensioning unit as claimed in claim 26, wherein a clutch is arranged between the transmission output and the belt reel, said clutch opening and closing as a function of a direction of rotation of its transmission side.

32. The belt tensioning unit as claimed in claim 17, wherein a clutch which can be actuated by external power is arranged between a transmission output and the belt reel.

33. The belt tensioning unit as claimed in claim 32, wherein the clutch is actuated electrically.

34. The belt tensioning unit as claimed in claim 19, wherein there is a rotational clearance between a motor-side part of a transmission input and a transmission output, and wherein a slipping clutch is arranged between the transmission input and the transmission output, via which slipping clutch the transmission output can be driven within the rotational clearance in a forward or a backward direction depending on a direction of rotation of the transmission input.

35. The belt tensioning unit as claimed in claim 20, wherein there is a rotational clearance between a motor-side part of a transmission input and a transmission output, and wherein a slipping clutch is arranged between the transmission input and the transmission output, via which slipping clutch the transmission output can be driven within the rotational clearance in a forward or a backward direction depending on a direction of rotation of the transmission input.

36. The belt tensioning unit as claimed in claim 21, wherein there is a rotational clearance between a motor-side part of a transmission input and a transmission output, and wherein a slipping clutch is arranged between the transmission input and the transmission output, via which slipping clutch the transmission output can be driven within the rotational clearance in a forward or a backward direction depending on a direction of rotation of the transmission input.
